(19) United States
(12) Patent Application Publication
(10) Pub. No.: US 2011/0090942 A1
(43) Pub. Date: Apr. 21, 2011

(54) SYSTEM AND METHODS FOR WIRELESS NETWORKING

(75) Inventors: Robert Hardacker, Escondido, CA (US); Thomas Dawson, Escondido, CA (US)

(73) Assignees: SONY CORPORATION, Tokyo (JP); SONY ELECTRONICS, INC., Park Ridge, NJ (US)

(21) Appl. No.: 12/579,599

(22) Filed: Oct. 15, 2009

(51) Int. Cl. H04B 1/38; G06F 15/173

(52) U.S. Cl. 375/220; 709/224

(57) ABSTRACT

A networking system for wirelessly transmitting a signal between one or more computers. The system includes, in a first transceiver pair, an upper transceiver configured to be coupled to be suspended overhead and lower transceiver configured as a ground unit. The upper and lower transceivers include an RF transmitter configured to transmit a first signal as a focused beam toward the opposing transceiver and an RF receiver configured to receive the first beam signal from the opposing transceiver. The system also includes, in a second transceiver pair, an RF transmitter configured to transmit a second signal as a focused beam toward the opposing transceiver and an RF receiver configured to receive the first beam signal from the opposing transceiver. The first and second beam signals are transmitted at a 60 GHz, allowing the first and second beam signals to be transmitted at a beam spread of less than 5 degrees.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to a networking system, and more particularly to a wireless networking system.

2. Description of Related Art

Wireless networking in commercial applications such as large convention centers can become problematic as channels are limited, range may encompass many people and the number of users competing for access can be high. Convention centers, offices, etc. incur large expenses whenever they change configurations. Traditional WiFi RF has too great a range & covers too many users to adequately service them all with its limited BW. Wired Enet, telco, coax cable, and the like drops normally are required if an office configuration is changed or a new convention moves to a new space. Thus one is posed with the choice of either wired cable drops to each location that are difficult to change or a slow shared wireless service.

In some cases such as a convention center, the cost of running long Ethernet cables to each booth is high. Cables stretching to the ceiling are unsightly or impractical and cables strewn along the floor are a safety hazard.

Accordingly, an object of the present invention is to provide a wireless system that can provide directed and focused wireless communications from a central server to selected, moveable locations within a room.

### BRIEF SUMMARY OF THE INVENTION

The present invention includes a grid of ceiling mounted high bandwidth RF transceivers configured to wirelessly transmit a signal for networking. By using mmWave (60 GHz) transceivers, the range and pattern spread is limited, requiring only a small number of channels. Because of the directional nature of the signal, in most cases a single channel is needed. Through the use of gigabit (or faster) bit-rates, and beam forming and beam steering, a single ceiling transceiver can service a set of customers without interfering with the adjacent piconet, re-using the same frequency. The large bit-rates ensure that each customer has adequate BW for all data and communication needs and all the transceivers can be the same. This allows each transceiver pair (floor and ceiling) to be the same which results in a robust, scalable and easily maintained wireless distribution system for large facilities.

An aspect of the invention is a network for wirelessly transmitting a signal between one or more computers. The network includes a first pair of opposing transceivers comprising an upper transceiver configured to be mounted or otherwise coupled to the ceiling or other overhead support structure, and a lower transceiver configured as a ground unit that can rest directly on the floor, or may be positioned on a desk, booth, or other intermediary structure(s) resting on or supported by the floor.

Each of the upper and lower transceivers comprises an RF transmitter configured to transmit a first signal as a focused beam toward the opposing transceiver, and an RF receiver configured to receive the first beam signal from the opposing transceiver.

In one embodiment, the first beam signal is transmitted at a beam spread of less than 20 degrees. Preferably, first beam signal is transmitted at a beam spread of less than 10 degrees. More preferably, the first beam signal is transmitted at a beam spread of less than 5 degrees, e.g. by transmitting the signal at a frequency ranging between approximately 57 GHz and approximately 64 GHz. The beam spread may also be adjusted using beam steering algorithms, e.g. depending upon the distance from floor to ceiling transmitters. With the beam steering capabilities of the present invention, the beam pattern may be adjustable pattern, for example with a nominal 20′ diameter floor pattern that can optionally be made smaller or larger. Thus, the beam forming algorithms of the present invention adjust the transmission similar to the way a spot light can be widened or narrowed. To find the transceiver below, the algorithm may be configured to start off with a wide beam, then “focus” in on for maximum signal strength, speed, and isolation from adjacent TX/RX pairs.

The upper transceiver is configured to connect to the Internet e.g. by a fiber optic line and modem, or the like, and wherein the lower transceiver is configured to be coupled to one or more computers, e.g. via a switch, router, hub, or similar device.

In a preferred embodiment, the network includes a second pair of transceivers (which may share the backbone with the first pair) via a multiplexer or the like) that are configured to simultaneously transmit a second beam signal at the same frequency within in the same room. The first pair of transceivers and second pair of transceivers may be part of an array of transceiver pairs (e.g. 3, 4, 5 or more transceiver pairs) operating simultaneously operating within a room (e.g. trade show floor) at the same frequency. The beam path and strength at the 60 GHz frequency allows the array of transceivers to simultaneously operate at the same frequency at a minimum distance of approximately of 20 feet between pairs, and preferably down to 5 feet between pairs. Tighter spacing may also be accomplished without interference, and the transceiver pairs may also be operated at different frequencies if spaced adjacent each other. Given the high bandwidth offered, such close spacing is not expected to be necessary. In one embodiment, there is a grid of available attachment points on the ceiling to allow the best placement for pairing the units together. Note that the “floor” unit may be mounted on top of a trade show booth or some other location where it has an unobstructed view of the ceiling.

In one embodiment, the transmitter comprises an array of RF antennas transmitting from a surface of the transmitter (e.g. IC substrate, or the like), wherein the antennas may be manipulated (e.g. electronically via phase and amplitude modification) to transmit the signal at a non-orthogonal angle with respect to the surface. The upper and lower transceivers preferably comprise a beam forming and steering module/software configured to direct the beam signal to the opposing transceiver and maintain focus on the opposing transceiver.

Another aspect is a method of wirelessly networking between one or more computers. The method includes the steps of installing a first pair of opposing transceivers within proximity to each other, the pair of transceivers comprising an upper transceiver and a lower transceiver, wherein the upper transceiver is mounted to an overhead support structure, and the lower transceiver is coupled to a ground support structure. A first beam signal is transmitted as a focused RF beam toward the opposing transceiver, which is then received from the opposing transceiver.

In a preferred embodiment, the first beam signal is transmitted at a beam spread of less than 5 degrees. This may be achieved by transmitting first beam signal at a frequency ranging between approximately 57 GHz and approximately 64 GHz.

In one embodiment, the first beam signal is transmitted from an array of RF antennas disposed within a surface of the transmitter, wherein the antennas may be manipulated to transmit the signal at a non-orthogonal angle with respect to the surface. Beam steering module may be used to steer the beam signal and maintain orientation of the beam signal at the opposing transceiver.

Another aspect is a system for wirelessly transmitting a signal between one or more computers. The system includes a first and second pair of opposing transceivers, each comprising an upper transceiver coupled to an overhead support structure and a lower transceiver coupled to a ground support structure. The upper and lower transceivers of the first pair comprise an RF transmitter configured to transmit a first signal as a focused beam toward the opposing transceiver and an RF receiver configured to receive the first beam signal from the opposing transceiver. The upper and lower transceivers of the second pair comprise an RF transmitter configured to transmit a second signal as a focused beam toward the opposing transceiver and an RF receiver configured to receive the first beam signal from the opposing transceiver. The upper transceivers are configured to be coupled in some manner to the Internet, and the lower transceivers are configured to be coupled to one or more computers. In a preferred embodiment, the upper transceivers are coupled to a central server that monitors network traffic levels in order to charge the users on the show floor by the amount of data transferred.

In a preferred embodiment, the first and second beam signals are transmitted at a 60 GHz (e.g. frequency ranging between approximately 57 GHz and approximately 64 GHz), thus allowing the first and second beam signals to be transmitted at a beam spread of less than 5 degrees.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic view of a wireless networking system in accordance with the present invention.

FIG. 2 is a schematic view of an array of wireless transceivers in accordance with the present invention.

FIG. 3 shows a schematic view of a transceiver in accordance with the present invention.

FIG. 4 illustrates various software components that may be stored in memory of the transceiver of FIG. 3.

FIG. 5 is a side view of a transmitter during synchronization of a transceiver pair.

FIG. 6 illustrates a top view of a transmitter in accordance with the present invention.

### DETAILED DESCRIPTION OF THE INVENTION

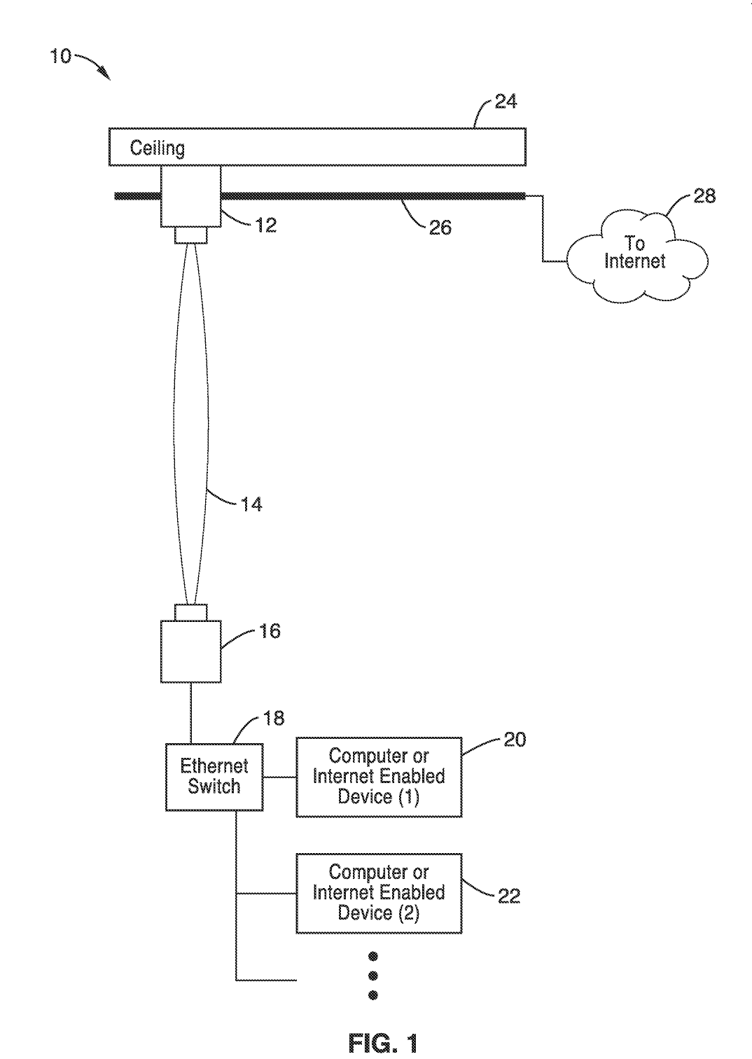

Referring more specifically to the drawings, for illustrative purposes the present invention is embodied in the apparatus generally shown in FIG. 1 through FIG. 6. It will be appreciated that the apparatus may vary as to configuration and as to details of the parts, and that the method may vary as to the specific steps and sequence, without departing from the basic concepts as disclosed herein.

FIG. 1 illustrates a wireless system 10 in accordance with the present invention that is configured to be connected to a fixed high speed backbone 26 for distributing to one or more locations within a room. The primary means of distribution is achieved via one or more focused beams 14 for transmission between an upper or “overhead” unit and a lower or “ground” unit. The overhead unit is configured to be mounted or otherwise coupled to a ceiling or other overhead support structure, and the ground unit is configured to rest directly on the floor or on a desk, booth, or one or more other intermediary structures resting on or supported by the floor. The system 10 is configured to operate at a bandwidth of several gigabits per second.

In the embodiment illustrated, the system 10 employs a pair of transceivers, such as an upper transceiver 12 supported by the ceiling 24, and lower transceiver 16 supported by the floor, which transmit and receive signal-containing beam 14. The lower transceiver 16 preferably has an unobstructed view of the upper transceiver 12. The upper transceiver 12 is coupled to backbone 26, which may comprise an optical line or the like. The backbone 26 is generally coupled to a server, modem or the like, providing access to the Internet 28.

In a preferred embodiment, the upper transceivers 12 are connected to a central device (e.g. server/multiplexer 27) that monitors network traffic levels in order to charge the users on the show floor by the amount of data transferred.

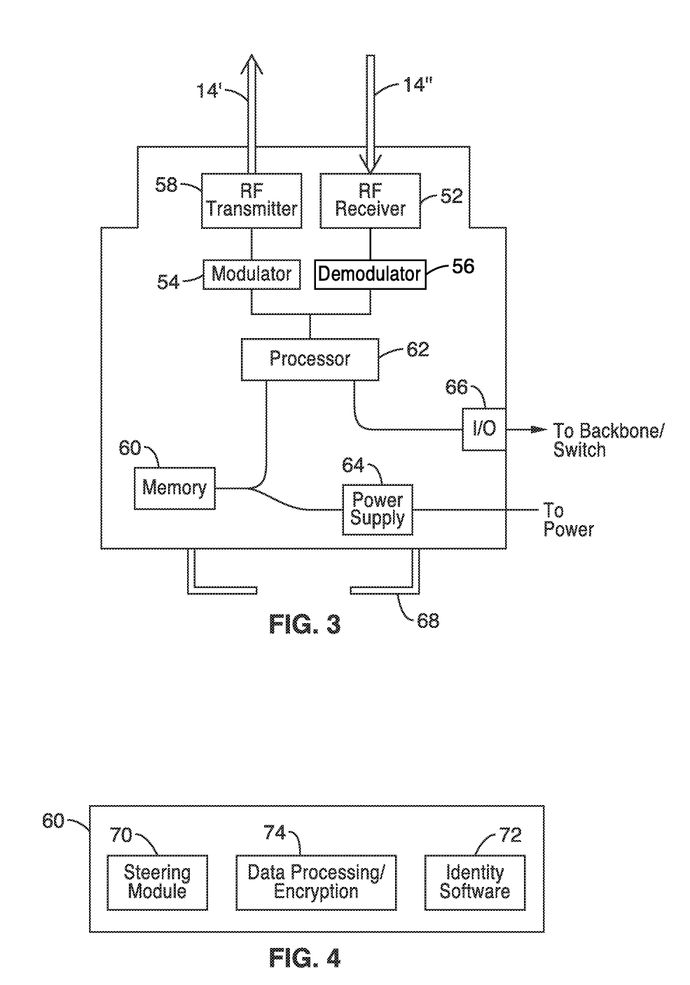

The upper transceiver 12 is configured to be coupled or mounted to an overhead support structure such as the ceiling 24 via a bracket 68 (see FIG. 3) or like fastening mechanism that holds the transceiver in place (behind the ceiling tile, plasterboard, behind a small plate or protruding through slightly). The upper transceiver 12 may be recessed within the ceiling 24 or mounted externally to it.

The lower transceiver 16 may be configured to rest directly on the floor, or may be positioned on a desk, booth, or other intermediary structure(s) resting on or supported by the floor. Lower transceiver 16 is coupled to a networking device 18 such as a switch, router, or hub that then transmits the signal to one or more computers or other Internet connected devices 20, 22. The lower transceiver 16 may connect to a distribution hub, such as an enet router, or directly to a PC, TV, STB, PVR, etc. in need of a network connection. Connection to end use devices 20-22 may be via an enet cable or some other proprietary means, but for office/convention center space enet would generally be preferred. Connectivity to individual devices may be via standardized or proprietary connectors.

The upper and lower transceivers are preferably configured to operate at a frequency band of approximately 57-64 GHz band (best known as 60 GHz), located in the millimeter-wave portion of the electromagnetic spectrum. While 60 GHz is ideal for use with the present invention, it is appreciated that other frequency bands (e.g. 80 GHZ E-band) may also be employed where appropriate. The advantages of this of using this band include interference mitigation, strong security, traffic prioritization (QoS), and frequency re-use within a fairly small area.

In particular, at 60 GHz, the transmitted beam 14 may be tightly focused to be near columnar at short distances (i.e. the beam spread for a 60 GHz transmission is less than 5 degrees). This allows the several transceiver 12/16 pairs to be used simultaneously and independently in parallel in relatively close proximity to each other. The narrow beamwidth of 60 GHz alleviates the possibilities of interference, but also focuses the power of the beam making for a strong link budget over its short transmission range which further mitigates interference.

At 60 GHz, the transceiver 12/16 pairs can have an ideal range of up 15-20 meters apart from each other, with nominal power consumption. This definable range, along with the finite beamwidth, also provide inherent security, as it is difficult to intercept the beam unless positioned within the beam path.

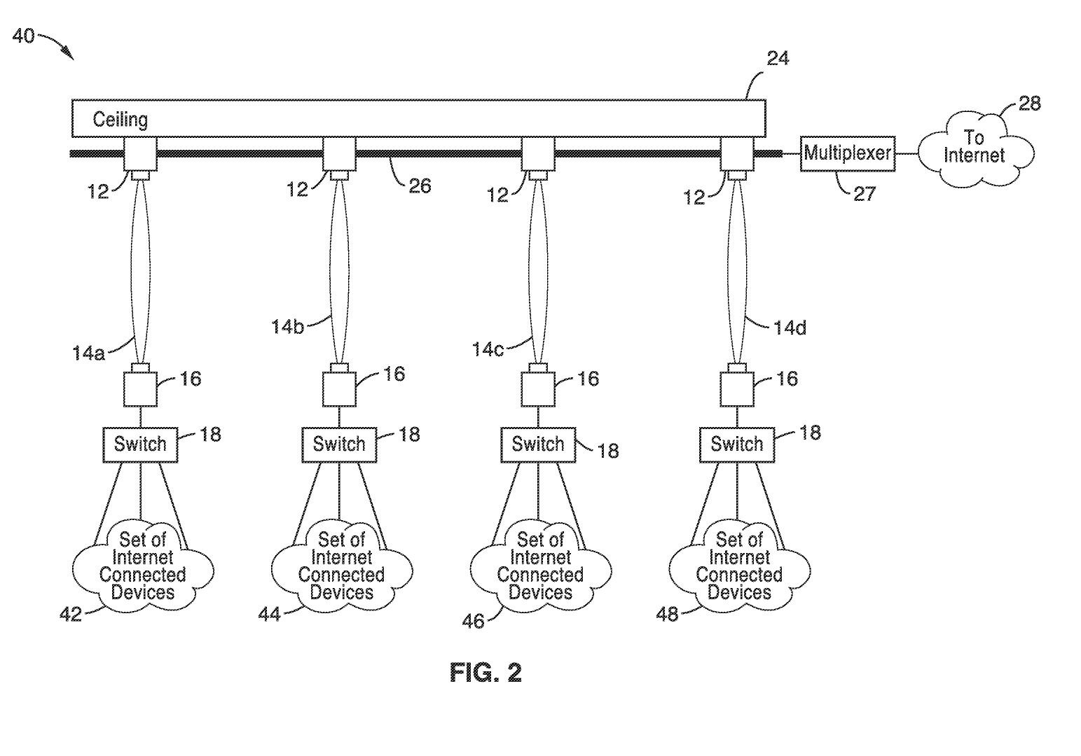

FIG. 2 illustrates a system 40 in accordance with the present invention employing a plurality or network of transceiver 12/16 pairs, each transmitting distinct beams 14A-14D to distinct locations within a room. A multiplexer 27 (e.g. any device or computer capable of performing TDM (Time Division Multiplexing) or the like) may be used to split the signal into one or more pairings. For example, beam 14A would connect backbone 26 to a set of individual Internet connected devices 42 independently and without interference from other networks in the room. Correspondingly, beam 14B would connect to set 44, beam 14C would connect to set 46, and beam 14D would connect to set 48. Although the system 40 is illustrated in FIG. 2 as having four distinct sets 42-48, it is appreciated that any number of individual networks may be employed.

Generally, the preferred maximum density of pairs 12/16 should be approximately 20 ft (i.e. 20 ft separation between transceiver pairs). However, this density may be optionally modified by using channels. For example, beam 14A may be transmitted at 59 GHz, while beam 14B is transmitted at 60 GHz, beam 14C transmitted at 61 GHz, and beam 14B transmitted at 62 GHz. This would allow the transceiver pairs to be positioned in closer range to each other without interference.

FIG. 3 illustrates an exemplary transceiver 12/16 in accordance with the present invention. The transceiver 12/16 illustrated in FIG. 3 may be used interchangeably on the ceiling or floor (e.g. units in each pairing may be identical with respect to upper transceiver 12 and lower transceiver 16, and also may be identical between sets 42-48). The transceivers 12/16 need not have any unique programming or configuration between sets or within a set.

Alternatively, the upper transceiver 12 may be specifically configured for use as a ceiling unit, e.g. have I/O port 66 specifically designed for connection to backbone 26, and/or have a mounting means 68 configured for mounting to ceiling 24. In such a configuration, the lower transceiver 16 may be specifically configured in a corresponding manner for use on the floor.

A further illustrated in FIG. 3, each transceiver 12/16 comprises an RF transmitter 50 and RF receiver 52. Transmitter 50 generates a focused beam of light 14′ toward the corresponding opposing unit, and receiver 52 receives focused beam 14″ from the opposing unit. A processor 62 modulates the signal via modulator 54 for outgoing transmission through transmitter 50, and demodulates the incoming signal from receiver 52 via demodulator 56. Each transceiver 12/16 may also comprise memory 60, input/output port 66, and power supply 64.

As shown in FIG. 6, the transmitter 50 preferably comprises an IC (e.g. 65 Nm or 90 Nm CMOS) having an array 84 of miniature antennas 82 embedded in substrate 80. FIG. 6 illustrates an 8×8 array 84. However, the array 84 may comprise any number of antennas 82. By increasing the number of antennas, range is increased, while also increasing the complexity of programming (e.g. steering algorithms explained in further detail below). The receiver 52 may have a similar array of antennas imprinted on the IC.

While RF transmission is the preferred means of transmission, it is appreciated that other transmission means that are capable of focusing a beam of light (e.g. laser etc.) may also be employed.

The narrow controlled beam path of the system 10 of the present invention provides inherent security, as it is difficult to intercept the signal. However memory 60 may include encryption software 74 to provide added security to the transmission.

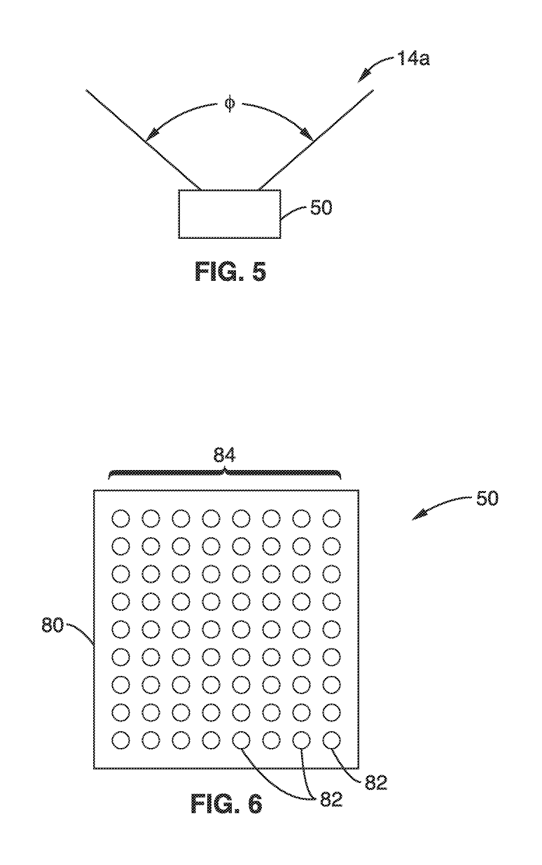

Because an office or trade booth may not be directly underneath the transceiver, or cause vibration and or movement between the upper transceiver and lower transceiver, beam steering may be employed to accommodate variations in position. Referring to FIGS. 4 and 5, the RF beam 14′ may be adjusted by manipulating the output of the RF transmitter 50 via an electronic steering module 70 stored in memory 60.

Steering module 70 comprises one or more beam steering/forming algorithms configured to direct the RF beam 14A toward the corresponding transceiver 12/16. Referring to FIG. 6, the steering algorithm is configured the transmit the beam pattern with an adjustable pattern, for example with a nominal 20′ diameter floor pattern that can optionally be made smaller or larger. While synching a pair of transceivers, the beam steering alogorithm defocus the beam so that a broad swath is included in the beam path. For sake of analogy, the beam forming algorithms of the present invention adjust the transmission similar to the way a spot light can be widened or narrowed. The beam path angle θ is increased until the opposing transceiver 12/16 receives the signal. By manipulating the phase and amplitude of the individual antennas, the beam path angle θ may increase from less than 5 degrees to up to 180 degrees. While the increased beam path decreases the signal strength and throughput, and is not generally desirable for transmitting data due to interference, the increase swath is acceptable during synchronization because large volumes of data are not yet being transmitted during this calibration.

The increased swath of the beam 14A may receive a number of different transceivers 12/16. Accordingly, each transceiver may be identifiable according to identity software 72 loaded in memory 60. The identity may be established by MAC address, IP address, manufacturing serial number, or the like. One the desired transceiver 12/16 is located, the beam forming algorithm may steer the beam in the direction (e.g. x, y plane) of the opposing transceiver, incrementally narrowing (focusing) the beam path swath and general angle of the beam until the beam is pointed at the opposing device at its smallest possible swath for maximum signal strength, speed, and isolation from adjacent TX/RX pairs.

Thus, even if the floor unit 16 is several feet away from the ceiling unit 12 (in horizontal x,y coordinates), the beam may be steered at an angle with respect to the mounting surface to focus the beam on the opposing transceiver.

When synchronized, the steering algorithm may continue to provide feedback on the positioning of the beam with respect to the position of the RF receiver 52 on opposing transceiver. Thus, if any shifting or vibration occurs between the upper and lower transceivers, the off center positioning of the beam is evaluated and the beam is modified to place the units in proper alignment.

The above beam forming and steering allows for frequency re-use in adjacent transceivers, simplifying implementation. The lower transceiver 16 generally employs the same high bit-rate beam forming & beam steering technology. The lower transceivers 16 only require AC power. Due to the large bandwidth capabilities, enet, telco, coax, etc may be muxed together & delivered wirelessly, greatly reducing installation & cost.

In an alternative embodiment, horn-type antennas may be used for transmitting the 60 GHz beam. An alignment mechanism, such as a laser pointer (not shown), may be used to ensure the antenna pair is aligned. For example, aligning the floor 16 and ceiling 12 transceivers may be accomplished by a number of means, including small diode lasers (e.g. laser pointers) that are built into the floor units 16, or attached to the floor unit 16 during alignment. The beam from the laser point may be used to steer and align the floor unit by pointing at specified, pre-calibrated target point on the ceiling unit to align the antennas.

Generally, the ceiling system (upper transceivers 12) are left in place and not changed. Signal strength would be one means to ensure best local peer-peer linkage of the floor-ceiling transceivers.

One particular advantage of the present invention is that if the floor plan changes, moving the floor transceivers 16 is all that is required. These could be rented or otherwise parsed out to the users. As the floor transceivers 16 need to point up, they can be placed conveniently to enable LOS connections without the concern of people/things getting in the way to break the beam.

Embodiments of the present invention are described with reference to flowchart illustrations of methods and systems according to embodiments of the invention. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s).

As can be seen, therefore, the present invention includes the following inventive embodiments among others:

1. A network for wirelessly transmitting a signal between one or more computers, comprising: a first pair of opposing transceivers comprising an upper transceiver and a lower transceiver; the upper transceiver configured to be coupled to an overhead support structure; the lower transceiver configured to be coupled to a ground support structure; wherein each of the upper and lower transceivers comprises an RF transmitter configured to transmit a first signal as a focused beam toward the opposing transceiver; and wherein each of the upper and lower transceivers comprises an RF receiver configured to receive the first beam signal from the opposing transceiver.

2. A network as recited in embodiment 1, wherein the first beam signal is transmitted at a beam spread of less than 5 degrees.

3. A network as recited in embodiment 1, wherein the first beam signal is transmitted at a frequency ranging between approximately 57 GHz and approximately 64 GHz.

4. A network as recited in embodiment 1, wherein the upper transceiver is configured to connect to the Internet, and wherein the lower transceiver is configured to be coupled to one or more computers.

5. A network as recited in embodiment 3, further comprising: a second pair of transceivers, wherein the second pair of transceivers are configured to simultaneously transmit a second beam signal at the same frequency within in the same room.

6. A network as recited in embodiment 5, wherein the first pair of transceivers and second pair of transceivers are part of an array of transceiver pairs simultaneously operating within a room at the same frequency.

7. A network as recited in embodiment 6, wherein the array of transceivers are configured to simultaneously operate at the same frequency at a minimum distance of approximately 20 feet from each other.

8. A network as recited in embodiment 3, wherein the transmitter comprises an array of RF antennas transmitting from a surface of the transmitter, and wherein the antennas may be manipulated to transmit the signal at a non-orthogonal angle with respect to the surface.

9. A network as recited in embodiment 8, wherein each of the upper and lower transceivers comprises a beam steering module configured to direct the beam signal to the opposing transceiver.

10. A method of wirelessly networking between one or more computers, comprising: installing a first pair of opposing transceivers within proximity to each other, the pair of transceivers comprising an upper transceiver and a lower transceiver; wherein the upper transceiver is coupled to an overhead support structure; wherein the lower transceiver is coupled to a ground support structure; transmitting a first signal as a focused RF beam toward the opposing transceiver; and receiving the first beam signal from the opposing transceiver.

11. A method as recited in embodiment 10, wherein the first beam signal is transmitted at a beam spread of less than 5 degrees.

12. A method as recited in embodiment 10, wherein the first beam signal is transmitted at a frequency ranging between approximately 57 GHz and approximately 64 GHz.

13. A method as recited in embodiment 10, wherein the upper transceiver is connected to the Internet, and wherein the lower transceiver is coupled to one or more computers.

14. A method as recited in embodiment 12, further comprising: simultaneously transmitting a second beam signal in the same room via a second pair of transceivers at the same frequency as the first signal.

15. A method as recited in embodiment 14, wherein the first pair of transceivers and second pair of transceivers are part of an array of transceiver pairs simultaneously operating within the room at the same frequency.

16. A method as recited in embodiment 15, wherein the array of transceivers simultaneously operate at the same frequency at a minimum distance of approximately 20 feet from each other.

17. A method as recited in embodiment 12, wherein the first beam signal is transmitted from an array of RF antennas disposed within a surface of the transmitter, the method further comprising: manipulating the antennas to transmit the signal at a non-orthogonal angle with respect to the surface.

18. A method as recited in embodiment 17, wherein each of the upper and lower transceivers comprises a beam steering module, the method further comprising: steering the beam signal to maintain orientation at the opposing transceiver.

19. A system for wirelessly transmitting a signal between one or more computers, comprising: first and second pair of opposing transceivers each comprising an upper transceiver and a lower transceiver; the upper transceiver configured to be coupled to an overhead support structure; the lower transceiver configured to be coupled to a ground support; wherein the upper and lower transceivers of the first pair comprise an RF transmitter configured to transmit a first signal as a focused beam toward the opposing transceiver and an RF receiver configured to receive the first beam signal from the opposing transceiver; wherein the upper and lower transceivers of the second pair comprise an RF transmitter configured to transmit a second signal as a focused beam toward the opposing transceiver and an RF receiver configured to receive the first beam signal from the opposing transceiver; and wherein the upper transceivers are configured to be coupled to the Internet, and wherein the lower transceivers are configured to be coupled to one or more computers.

20. A system as recited in embodiment 19, wherein the first and second beam signals are transmitted at a beam spread of less than 5 degrees.

21. A system as recited in embodiment 19, wherein the first and second beam signals are transmitted at a frequency ranging between approximately 57 GHz and approximately 64 GHz.

22. A system as recited in embodiment 21, wherein the first pair of transceivers and second pair of transceivers are part of an array of transceiver pairs configured to simultaneously operate within a room at the same frequency.

23. A system as recited in embodiment 21, wherein the array of transceivers are configured to simultaneously operate at the same frequency at a minimum distance of approximately 20 feet from each other.

24. A system as recited in embodiment 21, wherein each of the upper and lower transceivers comprises a beam steering module configured to direct the beam signal to the opposing transceiver.

25. A system as recited in embodiment 21, wherein the upper transceivers are configured to be coupled to a server; said server configured to monitor network traffic levels to determine the amount of data transferred by each transceiver pair.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A network for wirelessly transmitting a signal between one or more computers, comprising:
a first pair of opposing transceivers comprising an upper transceiver and a lower transceiver;
the upper transceiver configured to be coupled to an overhead support structure;
the lower transceiver configured to be coupled to a ground support structure;
wherein each of the upper and lower transceivers comprises an RF transmitter configured to transmit a first signal as a focused beam toward the opposing transceiver; and
wherein each of the upper and lower transceivers comprises an RF receiver configured to receive the first beam signal from the opposing transceiver.

2. A network as recited in claim 1, wherein the first beam signal is transmitted at a beam spread of less than 5 degrees.

3. A network as recited in claim 1, wherein the first beam signal is transmitted at a frequency ranging between approximately 57 GHz and approximately 64 GHz.

4. A network as recited in claim 1, wherein the upper transceiver is configured to connect to the Internet, and wherein the lower transceiver is configured to be coupled to one or more computers.

5. A network as recited in claim 3, further comprising:
a second pair of transceivers, wherein the second pair of transceivers are configured to simultaneously transmit a second beam signal at the same frequency within in the same room.

6. A network as recited in claim 5, wherein the first pair of transceivers and second pair of transceivers are part of an array of transceiver pairs simultaneously operating within a room at the same frequency.

7. A network as recited in claim 6, wherein the array of transceivers are configured to simultaneously operate at the same frequency at a minimum distance of approximately 20 feet from each other.

8. A network as recited in claim 3, wherein the transmitter comprises an array of RF antennas transmitting from a surface of the transmitter, and wherein the antennas may be manipulated to transmit the signal at a non-orthogonal angle with respect to the surface.

9. A network as recited in claim 8, wherein each of the upper and lower transceivers comprises a beam steering module configured to direct the beam signal to the opposing transceiver.

10. A method of wirelessly networking between one or more computers, comprising:
installing a first pair of opposing transceivers within proximity to each other, the pair of transceivers comprising an upper transceiver and a lower transceiver;
wherein the upper transceiver is coupled to an overhead support structure;
wherein the lower transceiver is coupled to an ground support structure;
transmitting a first signal as a focused RF beam toward the opposing transceiver; and
receiving the first beam signal from the opposing transceiver.

11. A method as recited in claim 10, wherein the first beam signal is transmitted at a beam spread of less than 5 degrees.

12. A method as recited in claim 10, wherein the first beam signal is transmitted at a frequency ranging between approximately 57 GHz and approximately 64 GHz.

13. A method as recited in claim 10, wherein the upper transceiver is connected to the Internet, and wherein the lower transceiver is coupled to one or more computers.

14. A method as recited in claim 12, further comprising:
simultaneously transmitting a second beam signal in the same room via a second pair of transceivers at the same frequency as the first signal.

15. A method as recited in claim 14, wherein the first pair of transceivers and second pair of transceivers are part of an array of transceiver pairs simultaneously operating within the room at the same frequency.

16. A method as recited in claim 15, wherein the array of transceivers simultaneously operate at the same frequency at a minimum distance of approximately 20 feet from each other.

17. A method as recited in claim 12, wherein the first beam signal is transmitted from an array of RF antennas disposed within a surface of the transmitter, the method further comprising:
manipulating the antennas to transmit the signal at a non-orthogonal angle with respect to the surface.

18. A method as recited in claim 17, wherein each of the upper and lower transceivers comprises a beam steering module, the method further comprising:
steering the beam signal to maintain orientation at the opposing transceiver.

19. A system for wirelessly transmitting a signal between one or more computers, comprising:
first and second pair of opposing transceivers each comprising an upper transceiver and a lower transceiver;
the upper transceiver configured to be coupled to an overhead supports structure;
the lower transceiver configured to be coupled to a ground support structure;
wherein the upper and lower transceivers of the first pair comprise an RF transmitter configured to transmit a first signal as a focused beam toward the opposing transceiver and an RF receiver configured to receive the first beam signal from the opposing transceiver;
wherein the upper and lower transceivers of the second pair comprise an RF transmitter configured to transmit a second signal as a focused beam toward the opposing transceiver and an RF receiver configured to receive the first beam signal from the opposing transceiver; and
wherein the upper transceivers are configured to be coupled to the Internet, and wherein the lower transceivers are configured to be coupled to one or more computers.

20. A system as recited in claim 19, wherein the first and second beam signals are transmitted at a beam spread of less than 5 degrees.

21. A system as recited in claim 19, wherein the first and second beam signals are transmitted at a frequency ranging between approximately 57 GHz and approximately 64 GHz.

22. A system as recited in claim 21, wherein the first pair of transceivers and second pair of transceivers are part of an array of transceiver pairs configured to simultaneously operate within a room at the same frequency.

23. A system as recited in claim 21, wherein the array of transceivers are configured to simultaneously operate at the same frequency at a minimum distance of approximately 20 feet from each other.

24. A system as recited in claim 21, wherein each of the upper and lower transceivers comprises a beam steering module configured to direct the beam signal to the opposing transceiver.

25. A system as recited in claim 21, wherein the upper transceivers are configured to be coupled to a server;
said server configured to monitor network traffic levels to determine the amount of data transferred by each transceiver pair.
